(19) United States
(12) Patent Application Publication
(10) Pub. No.: US 2020/0151810 A1
(43) Pub. Date: May 14, 2020

(54) IMPLEMENTING A VIRTUAL MONETARY ACCOUNT

(71) Applicant: International Business Machines Corporation, Armonk, NY (US)

(72) Inventors: Daniel F. Gruhl, San Jose, CA (US); Christian B. Kau, Mountain View, CA (US); Chad E. DeLuca, Morgan Hill, CA (US); Anna Lisa Gentile, San Jose, CA (US); Alfredo Alba, Morgan Hill, CA (US); Linda H. Kato, San Jose, CA (US); Steven R. Welch, Gilroy, CA (US)

(21) Appl. No.: 16/190,002

(22) Filed: Nov. 13, 2018

(51) Int. Cl. G06Q 40/02; G06Q 20/10; G06Q 20/40; G06Q 20/36

(52) U.S. Cl. CPC G06Q 40/02; G06Q 20/108; G06Q 20/367; G06Q 20/405; G06Q 20/401

(57) ABSTRACT

A computer-implemented method according to one embodiment includes receiving a request to perform an action associated with a virtual monetary account, applying one or more rules associated with the virtual monetary account to one or more characteristics of the request, and conditionally implementing the request, based on results of the applying.

### BACKGROUND

The present invention relates to transaction analysis, and more specifically, this invention relates to contextual transaction analysis and regulation in association with a virtual monetary account.

Monetary accounts are a common means to store and transfer monetary funds. However, knowledge of a single routing transfer number allows access to a monetary account, with little regulation controlling monetary funds deposited and withdrawn from the account. This results in poor security for the monetary account, as well as a threat of unauthorized account access that is difficult and time-consuming to resolve.

### SUMMARY

A computer-implemented method according to one embodiment includes receiving a request to perform an action associated with a virtual monetary account, applying one or more rules associated with the virtual monetary account to one or more characteristics of the request, and conditionally implementing the request, based on results of the applying.

According to another embodiment, a computer program product for implementing a virtual monetary account includes a computer readable storage medium that has program instructions embodied therewith, where the computer readable storage medium is not a transitory signal per se, and where the program instructions are executable by a processor to cause the processor to perform a method including receiving, by the processor, a request to perform an action associated with a virtual monetary account, applying, by the processor, one or more rules associated with the virtual monetary account to one or more characteristics of the request, and conditionally implementing the request, by the processor, based on results of the applying.

According to another embodiment, a system includes a processor, and logic integrated with the processor, executable by the processor, or integrated with and executable by the processor, where the logic is configured to receive a request to perform an action associated with a virtual monetary account, apply one or more rules associated with the virtual monetary account to one or more characteristics of the request, and conditionally implement the request, based on results of the applying.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 illustrates a method for implementing a virtual monetary account, in accordance with one embodiment.

FIG. 4 illustrates an exemplary virtual monetary account implementation, in accordance with one embodiment.

FIG. 5 illustrates an exemplary secure banking environment, in accordance with one embodiment.

### DETAILED DESCRIPTION

The following description discloses several preferred embodiments of systems, methods and computer program products for implementing a virtual monetary account. Various embodiments provide a method to apply rules to characteristics of a request associated with a virtual monetary account, and conditionally implement the request, based on the applying.

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “includes” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for implementing a virtual monetary account.

In one general embodiment, a computer-implemented method includes receiving a request to perform an action associated with a virtual monetary account, applying one or more rules associated with the virtual monetary account to one or more characteristics of the request, and conditionally implementing the request, based on results of the applying.

In another general embodiment, a computer program product for implementing a virtual monetary account includes a computer readable storage medium that has program instructions embodied therewith, where the computer readable storage medium is not a transitory signal per se, and where the program instructions are executable by a processor to cause the processor to perform a method including receiving, by the processor, a request to perform an action associated with a virtual monetary account, applying, by the processor, one or more rules associated with the virtual monetary account to one or more characteristics of the request, and conditionally implementing the request, by the processor, based on results of the applying.

In another general embodiment, a system includes a processor, and logic integrated with the processor, executable by the processor, or integrated with and executable by the processor, where the logic is configured to receive a request to perform an action associated with a virtual monetary account, apply one or more rules associated with the virtual monetary account to one or more characteristics of the request, and conditionally implement the request, based on results of the applying.

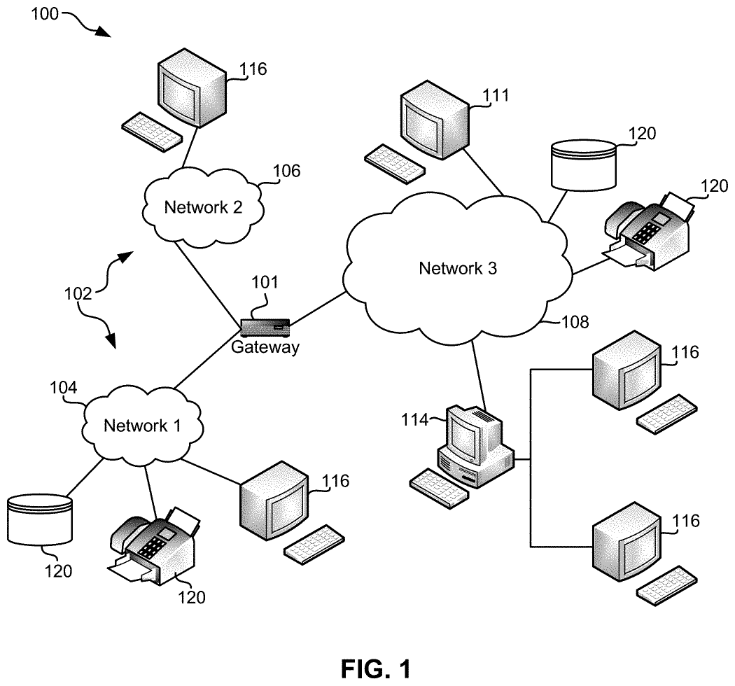

FIG. 1 illustrates an architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. User devices 116 may also be connected directly through one of the networks 104, 106, 108. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

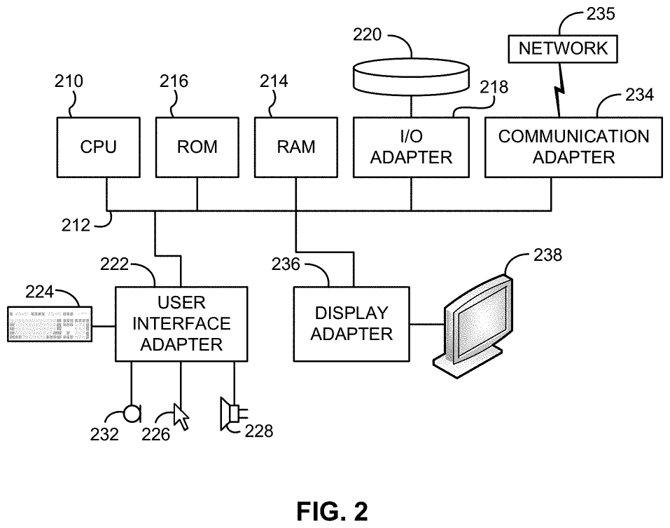

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a MAC OS, a UNIX OS, etc. It will be appreciated that a preferred embodiment may also be implemented on platforms and operating systems other than those mentioned. A preferred embodiment may be written using XML, C, and/or C++ language, or other programming languages, along with an object oriented programming methodology. Object oriented programming (OOP), which has become increasingly used to develop complex applications, may be used.

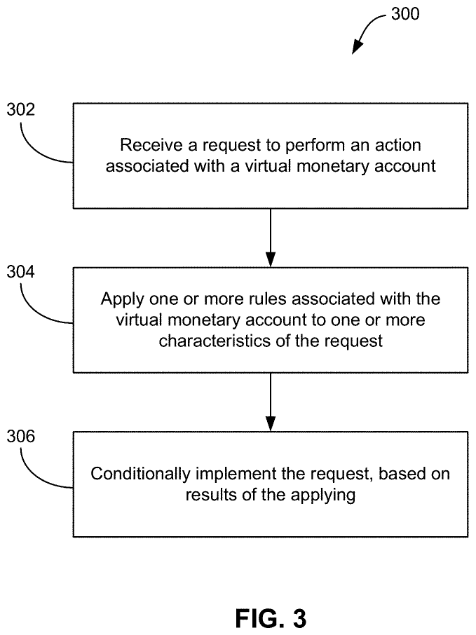

Now referring to FIG. 3, a flowchart of a method 300 is shown according to one embodiment. The method 300 may be performed in accordance with the present invention in any of the environments depicted in FIGS. 1, 2, 4, and 5, among others, in various embodiments. Of course, more or less operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3, method 300 may initiate with operation 302, where a request to perform an action associated with a virtual monetary account is received. In one embodiment, the virtual monetary account may include an account from which monetary funds may be withdrawn and/or to which monetary funds may be added. In another embodiment, the virtual monetary account may be associated with a source monetary account. For example, the source monetary account may include any monetary account that is capable of holding, receiving, and/or disseminating monetary funds. In another example, the source monetary account may be established by a bank, credit union, etc.

Additionally, in one embodiment, the virtual monetary account may be created as an extension of the source monetary account. For example, the virtual monetary account may have access to all or a predetermined portion of monetary funds in the source monetary account. In another example, funds from the source monetary account may be transferred to the virtual monetary account only when such funds are successfully withdrawn from the virtual monetary account. In yet another example, both the virtual monetary account and the source monetary account may be created by, an associated with, a single entity (e.g., a user, an organization, an application, etc.).

Further, in one embodiment, the source monetary account may include one or more of a checking account, a savings account, etc. In another embodiment, the virtual monetary account may be linked to the source monetary account. For example, the virtual monetary account may be capable of receiving monetary funds from the source monetary account. In another example, the virtual monetary account may be capable of sending monetary funds to the source monetary account.

Further still, in one embodiment, the virtual monetary account may have a first identifier that is different from a second identifier of the source monetary account. For example, the first identifier may include a unique routing number (URN) identifying the virtual monetary account. In another example, the second identifier may include a routing transfer number/ABA number used to identify the source monetary account.

Also, in one embodiment, data associated with the virtual monetary account may be stored on one or more computing devices, such as one or more servers, a distributed computing and/or storage system, a cloud computing environment, etc. In another embodiment, the data may include an amount of monetary funds available for withdrawal from the virtual monetary account, one or more criteria associated with withdrawing monetary funds from the virtual monetary account, one or more criteria associated with depositing monetary funds to the virtual monetary account, etc.

In addition, in one embodiment, a plurality of different virtual monetary accounts may be created for a single source monetary account. For example, each of the different virtual monetary accounts may be authorized to send and/or receive monetary funds from a unique entity (e.g., an individual, an application, an organization, etc.). In another embodiment, the request to perform the action may include a request to withdraw a particular amount of monetary funds from the virtual monetary account.

Furthermore, in one embodiment, the request to perform the action may include a request to deposit a particular amount of monetary funds to the virtual monetary account. In another embodiment, the request to perform the action may include an identifier identifying the virtual monetary account. In yet another embodiment, the request to perform the action may include an identifier of a payment account from which funds are to be transferred to the virtual monetary account.

Further still, in one embodiment, the request to perform the action may include an identifier of a recipient account to which funds are to be transferred from the virtual monetary account. In another embodiment, the request to perform the action may originate at a mobile computing device, a desktop computing device, one or more servers, etc.

Also, method 300 may proceed with operation 304, where one or more rules associated with the virtual monetary account are applied to one or more characteristics of the request. In one embodiment, the one or more characteristics of the request may include an identity of an entity sending the request. In another embodiment, the one or more characteristics of the request may include a date and/or time that the request was received.

Additionally, in one embodiment, the one or more characteristics of the request may include a monetary amount associated with the request. In another embodiment, the one or more characteristics of the request may include an indication as to whether the request is a withdraw request or a deposit request. In yet another embodiment, the one or more characteristics of the request may include a geographical location where the request originated.

Further, in one embodiment, the one or more rules may include one or more predetermined transfer rules. For example, the one or more rules may manage a transfer of monetary funds to and from the virtual monetary account. In another embodiment, the one or more rules may be stored as metadata in association with the virtual monetary account. In yet another embodiment, the one or more rules may indicate times and/or dates for which a request may be considered valid.

Further still, in one embodiment, the one or more rules may indicate a threshold monetary amount. In another embodiment, the one or more rules may indicate one or more valid geographical origins for the request. In yet another embodiment, the one or more rules may indicate a predetermined distance from a current location of a user associated with the virtual monetary account.

For example, a current location may be determined for a user (utilizing a global positioning system (GPS) module of a mobile device of the user, etc.). In another embodiment, a geographical location where the request originated may be compared to the current location of the user. In yet another embodiment, the request may be considered valid if the difference in distance between the geographical location where the request originated and the current location of the user is less than a predetermined threshold.

Also, in one embodiment, one or more of the rules may be created in response to monitoring one or more external factors associated with the virtual monetary account and/or the request. For example, the virtual monetary account may be associated with a predetermined bill to be paid (e.g., power bill, loan repayment, etc.). In another example, one or more historical payments of the predetermined bill may be monitored and/or logged. For instance, the logged information may include a monetary payment amount, a time/date of the payment, etc.

In addition, in one example, a predicted payment amount may be estimated, based on one or more patterns derived from the historical payments. In another example, historical resource usage associated with historical requests may also be monitored and/or logged. In yet another example, the historical resource usage and historical requests may be compared to a current resource usage and the current request.

In still another example, a first ratio of a current resource usage to an amount associated with the request may be compared to a second ratio of an average historical resource usage to an average monetary amount associated with historical requests. For instance, the request may be considered valid if a difference between the first ratio and the second ratio is less than a predetermined threshold. In another example, an averaged time and date of historical requests may be compared to a time and date of the current request. For instance, the request may be considered valid if a difference between the averaged time and date of historical requests and a time and date of the current request is less than a predetermined threshold.

Furthermore, in one embodiment, the one or more rules may be periodically updated, based on the monitoring. In another embodiment, the one or more rules may indicate a maximum number of transactions for the virtual monetary account during a predetermined time period. For example, a counter may be incremented each time a transaction (e.g., deposit and/or withdrawal) is completed in association with the virtual monetary account. In another example, a first counter may be associated with a number of deposits made to the virtual account for the predetermined time period, and a second counter may be associated with a number of withdrawals made from the virtual account for the predetermined time period. In yet another example, once the counter reaches a threshold number, future requests may be considered invalid.

Further still, method 300 may proceed with operation 306, where the request is conditionally implemented, based on results of the applying. In one embodiment, the request may be implemented in response to determining that the request is valid when the one or more rules associated with the virtual monetary account are applied to one or more characteristics of the request. In another embodiment, if the request includes a request to withdraw a predetermined amount of monetary funds from the virtual monetary account, implementing the request may include first transferring the predetermined amount of monetary funds from the source monetary account to the virtual monetary account, and then transferring the predetermined amount of monetary funds from the virtual monetary account to a destination account associated with the request.

Also, in one embodiment, if the request includes a request to deposit a predetermined amount of monetary funds into the virtual monetary account, implementing the request may include first transferring the predetermined amount of monetary funds from an account associated with the request to the virtual monetary account, and then transferring the predetermined amount of monetary funds from the virtual monetary account to the source monetary account. In another embodiment, transferring a predetermined amount of monetary funds from a first account to a second account may include decrementing the predetermined amount from a total amount of monetary funds at the first account, and adding the predetermined amount from a total amount of monetary funds at the second account.

Additionally, in one embodiment, monetary funds may be transferred between the virtual monetary account and the source monetary account utilizing a unique routing number (URN) of the virtual monetary account and a routing transfer number/ABA number of the source monetary account. In another embodiment, a user associated with the virtual account may be notified before the request is implemented. For example, the user may need to explicitly approve the request (e.g., utilizing a graphical user interface (GUI) of a device) before the request may be implemented.

In this way, a security of a source monetary account may be improved by implementing the virtual monetary account in association with the source monetary account. The virtual monetary account may prevent unauthorized access to the source monetary account by implementing one or more rules governing the transfer of monetary funds to and from the virtual monetary account. This may reduce an amount of processing performed by one or more computing devices implementing the source monetary account, thereby improving a performance of the one or more computing devices. Additionally, a routing transfer number of the source monetary account may not need to be altered in order to implement security for the source monetary account.

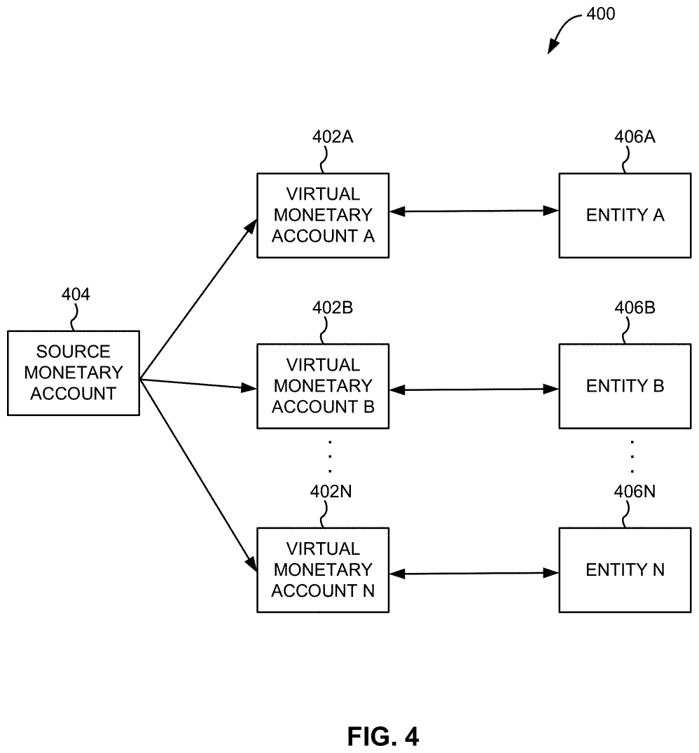

FIG. 4 illustrates an exemplary virtual monetary account implementation 400, according to one embodiment. As shown, a plurality of virtual monetary accounts 402A-N are created in association with a source monetary account 404. In one embodiment, each of the plurality of virtual monetary accounts 402A-N may be linked to the source monetary account 404 (e.g., via one or more pointers stored at each of the plurality of virtual monetary accounts 402A-N that point to the source monetary account 404, etc.).

Additionally, in one embodiment, each of the plurality of virtual monetary accounts 402A-N may include a unique routing number (URN) that allows conditional access to the plurality of virtual monetary accounts 402A-N. In another embodiment, each of the plurality of virtual monetary accounts 402A-N may also include a unique routing number (URN) that is provided to a respective one of a plurality of entities 406A-N for use. In yet another embodiment, each of the plurality of entities 406A-N may be associated with a separate monetary account.

As a result, a routing transfer number of a source monetary account 404 may be withheld from the plurality of entities 406A-N, and the plurality of entities 406A-N may be provided a URN of a respective one of the plurality of virtual monetary accounts 402A-N to indirectly deposit or withdraw monetary funds from the source monetary account 404.

Further, in one embodiment, each of the plurality of virtual monetary accounts 402A-N may include one or more rules that control the ability of a respective one of the plurality of entities 406A-N to withdraw or deposit monetary funds from the source monetary account 404 via a respective virtual monetary account 402A-N.

For example, if a first entity 406A sends a request to withdraw monetary funds from the first virtual monetary account 402A, one or more rules associated with the first virtual monetary account 402A may be applied to one or more characteristics of the request. If it is determined that the request is valid, based on the application of the one or more rules to the one or more request characteristics, the requested monetary funds may be transferred first from the source monetary account 404 to the first virtual monetary account 402A, and then to the requesting first entity 406A. However, if it is determined that the request is not valid, based on the application of the one or more rules to the one or more request characteristics, no monetary funds may be transferred. In another embodiment, a user associated with the source monetary account 404 may be notified and/or asked to validate the request, if the request is determined to not be valid.

Further still, in one embodiment, rules associated with one or more of the virtual monetary accounts 402A-N may be updated. In another embodiment, one or more additional virtual monetary accounts 402A-N may be created for the source monetary account 404. In yet another embodiment, one or more of the virtual monetary accounts 402A-N may be removed.

In this way, the plurality of virtual monetary accounts 402A-N may protect the source monetary account 404 from unauthorized access, which may improve a security of one or more computing devices storing data and providing services associated with the source monetary account 404.

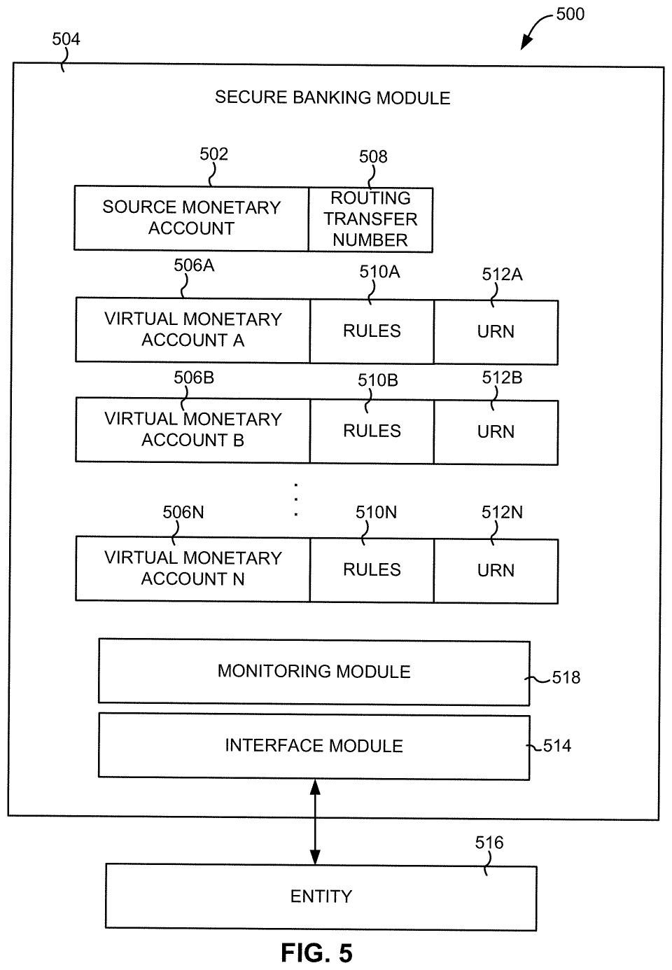

FIG. 5 illustrates an exemplary secure banking environment 500, according to one embodiment. As shown, a source monetary account 502 with an associated routing transfer number 508 is created and stored within a secure banking module 504. In one embodiment, the secure banking module 504 may include one or more applications running within one or more computing devices (e.g., one or more servers, one or more distributed computing devices, one or more cloud computing devices, etc.).

Additionally, a plurality of virtual monetary accounts 506A-N are created in association with the source monetary account 502. Each of the virtual monetary accounts 506A-N has an associated set of rules 510A-N, as well as an associated unique routing number (URN) 512A-N. In one embodiment, the rules 510A-N and URN 512A-N may be stored as metadata in association with the respective virtual monetary account 506A-N.

Further, in one embodiment, an interface module 514 of the secure banking module 504 may receive a request from an entity 516. The entity may include one or more of a user, an application, an organization, etc. In another embodiment, the interface module 514 may utilize one or more application programming interfaces (APIs) to receive the request. In yet another embodiment, the interface module 514 may utilize one or more graphical user interfaces (GUIs) to receive the request.

Further still, in one embodiment, the request may be parsed in order to determine a URN associated with the request. The URN associated with the request may be compared against the stored URNs 512A-N in order to determine a matching virtual monetary account 506A-N associated with the request. Rules 510A-N associated with the matching virtual monetary account 506A-N may then be applied to one or more characteristics of the request in order to determine whether the request is valid.

In one example, the request received at the interface module 514 from the entity 516 may include a request that includes a URN matching the first URN 512A of the first virtual monetary account 506A. The request may also include a request for a withdrawal of a predetermined amount of monetary funds. The secure banking module 504 may apply the first set of rules 510A to the characteristics of the request. If the result of applying the first set of rules 510A to the characteristics of the request results in a determination that the request is valid, the predetermined amount of monetary funds may be transferred first from the source monetary account 502 to the first virtual monetary account 506A, and then from the first virtual monetary account 506A to the entity 516.

Also, in another example, the request received at the interface module 514 from the entity 516 may include a request that includes a URN matching the second URN 512B of the second virtual monetary account 506B. The request may also include a request to deposit of a predetermined amount of monetary funds. The secure banking module 504 may apply the second set of rules 510B to the characteristics of the request. For example, the second set of rules 510B may indicate that only monetary fund deposits are allowed to the second virtual monetary account 506B.

Therefore, applying the second set of rules 510B to the characteristics of the request results in a determination that the request is valid, the predetermined amount of monetary funds may be transferred first from the entity 516 to the second virtual monetary account 506B, and then from the second virtual monetary account 506B to the source monetary account 502.

However, a second request received at the interface module 514 from the entity 516 may include a request that includes a URN matching the second URN 512B of the second virtual monetary account 506B. The request may also include a request to withdraw a predetermined amount of monetary funds. The secure banking module 504 may apply the second set of rules 510B to the characteristics of the request, where the second set of rules 510B indicates that only monetary fund deposits are allowed to the second virtual monetary account 506B.

Therefore, applying the second set of rules 510B to the characteristics of the request results in a determination that the request is not valid, the predetermined amount of monetary funds may not be transferred from the source monetary account 502 to the entity 516 via the second virtual monetary account 506B.

Additionally, in one embodiment, a monitoring module 518 may be used to monitor one or more external factors and update one or more of the sets of rules 510A-N, based on those factors. For example, an Nth virtual monetary account 506N may be associated with paying an electricity bill for a household. The monitoring module 518 may track a local temperature for the household over a predetermined time period (e.g., a month, etc.), and may approximate an electricity usage for the household, based on the local temperature. The monitoring module 518 may also store and analyze historical electricity usage for the household in order to make a more accurate electricity usage approximation.

Further, in one embodiment, the secure banking module 504 may analyze the approximated electricity usage provided by the monitoring module 518, and may determine an estimated electricity bill for the household based on the approximated electricity usage. This estimated electricity bill may be stored within the Nth set of rules 510N for the Nth virtual monetary account 506N. For instance, the Nth set of rules 510N may dictate that a request may be considered valid only if the request includes a request for a withdrawal of an amount of monetary funds that is within a predetermined percentage of the estimated electricity bill. Other rules within the Nth set of rules 510N may dictate that the request may be considered valid only if the request is received from an authorized utilities company within a predetermined number of days of a predetermined month.

Further still, in one example, a third request received at the interface module 514 from the entity 516 may include a request that includes a URN matching the Nth URN 512N of the Nth virtual monetary account 506N. The request may also include a request to withdraw a predetermined amount of monetary funds. The secure banking module 504 may apply the Nth set of rules 510N to the characteristics of the request in order to determine whether the request is valid.

Although the monitoring module 518 is shown as a component of the secure banking module 504, it should be noted that the monitoring module 518 may be independent from the secure banking module 504, and may send monitoring results to the secure banking module 504 (e.g., via the interface module 514 or another module, etc.).

Virtual Accounts for Secure Banking

Today there are multiple mechanisms for transaction payments (e.g. Credit Cards, online payment, etc.), all of which use a banking account's ABA routing number. For bank accounts, the routing transfer number (or ABA number) is currently used by banks to identify financial institutions within the United States. A user may provide their ABA number to any institution in order to authorize direct deposit, direct payment of consumer bills, electronic funds transfer, etc. Once provided with an ABA number, a company/merchant/retailer/individual can withdraw from it with little restriction and in this case the user is held accountable. This forces the responsibility of managing and protecting the ABA routing information on to the consumer and places the burden of merchant trust on the consumer. Moreover, if the merchant is hacked, the user's banking account information could be compromised in a way that is not easily detectable with the limited visibility to the consumer.

When banking fraud occurs, the consumer is usually the one who is liable for it. A solution to this problem is a granular way to protect a consumer's main bank account by giving the possibility of creating several virtual accounts with limited access and funds availability. The consumer can define a different behavior for each of their virtual accounts. Each virtual account can have independent funds, availability thresholds, and accessibility features—the consumer can define the set of parties that are authorized to withdraw from it. Each virtual account is connected to the main bank account but is not materialized, so consumers do not need to set aside actual fund in the account. Nevertheless, the virtual account externally appears like a standard account. This way the main bank account remains only visible to the consumer and it never gets revealed to external parties. The value for the consumer is greater security and less risk of fraud and liability. The value for the financial institution resides in perceived added value in terms of customer satisfaction, customer retainment and potentially limited liability and reduced money loss.

The invention provides a system and method for creating a unique routing number (URN) with “auditors” (e.g., rule based code segments) that allow an individual/company to withdraw money from the main bank account. The auditor has a set of rules that prevents others from withdrawing more than intended to provide security and minimize loss. Once the consumer no longer needs to make a payment to an individual or company, the unique routing number may be removed/revoked and the main banking account is not affected.

In one embodiment, an auditor may implement one or more variances. For example, rules associated with a virtual account may indicate a predetermined amount that is authorized to be withdrawn from the virtual account on a predetermined basis (e.g., monthly, yearly, weekly, etc.). In another example, the rules may allow for a predetermined increase in an authorized amount over a predetermined time (e.g., a monthly 10 percent increase). In yet another example, the rules may implement a maximum amount of funds that are allowed to be withdrawn from a virtual account, where the maximum amount varies periodically, based on resource usage, etc.

In another embodiment, the rules may limit a virtual account to a predetermined number of transactions for a predetermined time (e.g., ten transactions per month, etc.). In yet another embodiment, the rules may require explicit user authorization for all transactions involving the virtual account. In still another embodiment, the rules may only allow withdrawals from the virtual account, or may only allow deposits to the virtual account.

Additionally, in one embodiment, the rules may only allow transactions on one or more predetermined days, and may only allow transactions to/from one or more predetermined accounts. In another embodiment, the rules may rely on local or third-party monitoring to provide threshold data that controls an amount of monetary funds available via the virtual account.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A computer-implemented method, comprising:
receiving a request to perform an action associated with a virtual monetary account;
applying one or more rules associated with the virtual monetary account to one or more characteristics of the request, wherein the one or more rules are stored as metadata in association with the virtual monetary account and indicate:
times and dates for which the request is considered valid, and
a maximum number of transactions for the virtual monetary account during a predetermined time period; and
conditionally implementing the request, based on results of the applying.

2. The computer-implemented method of claim 1, wherein the virtual monetary account is created as an extension of a source monetary account, and the source monetary account includes a checking account or a savings account.

3. The computer-implemented method of claim 1, wherein the virtual monetary account has a unique routing number (URN) identifying the virtual monetary account that is different from a routing transfer number of a source monetary account.

4. The computer-implemented method of claim 1, wherein the one or more characteristics of the request include an identity of an entity sending the request.

5. The computer-implemented method of claim 1, wherein the one or more characteristics of the request include a date and time that the request was received.

6. The computer-implemented method of claim 1, wherein the one or more characteristics of the request include a monetary amount associated with the request.

7. The computer-implemented method of claim 1, wherein one or more characteristics of the request include an indication as to whether the request is a withdraw request or a deposit request.

8. The computer-implemented method of claim 1, wherein the one or more rules include one or more predetermined transfer rules that manage a transfer of monetary funds to and from the virtual monetary account.

9. The computer-implemented method of claim 1, wherein:
the virtual monetary account is created as an extension of a source monetary account, and the source monetary account includes a checking account or a savings account,
the virtual monetary account has a unique routing number (URN) identifying the virtual monetary account that is different from a routing transfer number of a source monetary account,
the one or more characteristics of the request include an identity of an entity sending the request,
the one or more rules are periodically updated, based on monitoring one or more external factors associated with the virtual monetary account, and
in response to determining that the request includes a request to withdraw a predetermined amount of monetary funds from the virtual monetary account, implementing the request includes first transferring the predetermined amount of monetary funds from a source monetary account to the virtual monetary account, and then transferring the predetermined amount of monetary funds from the virtual monetary account to a destination account associated with the request.

10. The computer-implemented method of claim 1, wherein the virtual monetary account is associated with a predetermined bill to be paid;
wherein the request includes a request for a monetary payment amount; and further comprising:
monitoring and logging information associated with a plurality of historical requests for payment of the predetermined bill, the logged information including a monetary payment amount;
monitoring and logging historical resource usage associated with the historical requests;
determining a first ratio of a current resource usage to the monetary payment amount of the request;
determining a second ratio of an average historical resource usage to an average monetary payment amount of the historical requests; and
determining that the request is valid in response to determining that a difference between the first ratio and the second ratio is less than a predetermined threshold.

11. The computer-implemented method of claim 1, wherein the one or more rules indicate a threshold monetary amount.

12. The computer-implemented method of claim 1, wherein the one or more rules indicate one or more valid geographical origins for the request.

13. The computer-implemented method of claim 1, wherein the one or more rules are periodically updated, based on monitoring one or more external factors associated with the virtual monetary account.

14. The computer-implemented method of claim 1, wherein the virtual monetary account is associated with a predetermined bill to be paid;
wherein the request includes a request for a monetary payment amount; and further comprising:
monitoring and logging information associated with a plurality of historical requests, the logged information including a time and date of the historical requests;
determining a time and date of the request to perform the action;
determining an averaged time and date of the logged information; and
determining that the request is valid in response to determining that a difference between the time and date of the request to perform the action and the averaged time and date of the logged information is less than a predetermined threshold.

15. The computer-implemented method of claim 1, wherein the request is implemented in response to determining that the request is valid when the one or more rules associated with the virtual monetary account are applied to the one or more characteristics of the request.

16. The computer-implemented method of claim 1, wherein in response to determining that the request includes a request to withdraw a predetermined amount of monetary funds from the virtual monetary account, implementing the request includes first transferring the predetermined amount of monetary funds from a source monetary account to the virtual monetary account, and then transferring the predetermined amount of monetary funds from the virtual monetary account to a destination account associated with the request.

17. A computer program product for implementing a virtual monetary account, the computer program product comprising a computer readable storage medium having program instructions embodied therewith, wherein the computer readable storage medium is not a transitory signal per se, the program instructions executable by a processor to cause the processor to perform a method comprising:
receiving, by the processor, a request to perform an action associated with a virtual monetary account;
applying, by the processor, one or more rules associated with the virtual monetary account to one or more characteristics of the request, wherein the one or more rules are stored as metadata in association with the virtual monetary account and indicate:
times and dates for which the request is considered valid, and
a maximum number of transactions for the virtual monetary account during a predetermined time period; and
conditionally implementing the request, by the processor, based on results of the applying.

18. The computer program product of claim 17, wherein the virtual monetary account is created as an extension of a source monetary account, and the source monetary account includes a checking account or a savings account.

19. The computer program product of claim 17, wherein the virtual monetary account has a unique routing number (URN) identifying the virtual monetary account that is different from a routing transfer number of a source monetary account.

20. A system, comprising:
a processor; and
logic integrated with the processor, executable by the processor, or integrated with and executable by the processor, the logic being configured to:
receive a request to perform an action associated with a virtual monetary account;
apply one or more rules associated with the virtual monetary account to one or more characteristics of the request, wherein the one or more rules are stored as metadata in association with the virtual monetary account and indicate:
times and dates for which the request is considered valid, and
a maximum number of transactions for the virtual monetary account during a predetermined time period; and
conditionally implement the request, based on results of the applying.
